(19) United States
(12) Patent Application Publication
(10) Pub. No.: US 2025/0168811 A1
(43) Pub. Date: May 22, 2025

(54) TRANSCEIVER ASSIGNMENT AND POSITION INITIALIZATION SYSTEM AND METHOD

(71) Applicant: Continental Automotive Systems, Inc., Auburn Hills, MI (US)

(72) Inventors: Delia Perez, Rochester Hills, MI (US); David Gutknecht, Bruce Township, MI (US); David James Reimus, Waterford, MI (US); John Oginsky, Bloomfield Hills, MI (US)

(73) Assignee: Continental Automotive Systems, Inc., Auburn Hills, MI (US)

(21) Appl. No.: 18/949,399

(22) Filed: Nov. 15, 2024

Related U.S. Application Data
(60) Provisional application No. 63/599,734, filed on Nov. 16, 2023.

(51) Int. Cl. H04W 64/00; H04L 45/02

(52) U.S. Cl. CPC H04W 64/00; H04L 45/02

(57) ABSTRACT

A controller may trigger, preferably via a wired network, at least one transceiver device to communicate its wireless identification. The controller may establish bidirectional communication with the at least one transceiver device. The bidirectional communication may comprise of wireless, wired, or mixed wireless and wired communication legs, paths or media. The controller may assign wired identification to the at least one transceiver device by utilizing the wireless identification. The wired identification may be based on the perceived physical location of the transceiver device. The perceived physical location of the transceiver device may be ascertained from wireless signal characteristics.

### BRIEF DESCRIPTION OF THE DRAWINGS

The present disclosure will become more fully understood from the detailed description and the accompanying drawings, wherein:

FIG. 1 shows a block diagram of exemplary embodiments of a method according to the disclosure;

FIG. 2 shows a block diagram of other exemplary embodiments of a method according to the disclosure;

FIG. 3 shows a block diagram of an exemplary system according to various embodiments.

### DETAILED DESCRIPTION

Localizing network devices often involves determining their physical or logical position within a network, which can be achieved through both wired and wireless communications. Wired localization typically relies on the physical connections and infrastructure, such as cables, hubs, gateways and switches, to pinpoint device locations based on the network topology and port assignments. This method is potentially highly accurate but may require additional hardware resources to facilitate. On the other hand, wireless localization uses wireless signals to estimate device positions through signal strength, time of flight, angle of arrival, etc., methods already supported by common wireless hardware. Moreover, wireless methods offer greater flexibility and mobility, making them more robust for dynamic environments at a potential cost of accuracy, reliability and security. Combining wired and wireless approaches for localizing network devices leverages the strengths of both methods to enhance accuracy, reliability and security.

As mentioned above, it is often desirable for localization systems to recognize the spatial orientation of various components, e.g. network devices. For example, signals received from a target device may be desired to have a reference in a coordinate system, whether the coordinate system is a traditional one such as, for example, cartesian, radial, spherical, etc. or nonstandard such as, for example, a location with respect to landmarks, distribution in a closed space, with respect to curved space. The coordinate system may instead or in addition be one that refers to other values, measurements, phenomena, etc., such as, for example, vector spaces, tensor spaces, gradients, fields, etc.

Accordingly, localization systems may create a map based on the perceived spatial orientation of devices that receive or transmit signals. Alternatively, or in addition to mapping, some systems may gather the identifications of these devices. However, a significant drawback of current methods based on wireless communication alone is that wireless signals can be intercepted by external actors, leading to potential replay, manipulation, spoofing, or other forms of compromise, thereby raising security concerns.

Another challenge within the localized system is assigning unique or particular identifications and relating them to predetermined physical locations.

Disclosed, among others, are devices, systems and ways of improving security by using wired and wireless communication to provide a localization system to devices in a manner which cannot be easily accessed by potentially rogue actors during map creation. Further disclosed are ways to assign unique identifications during system initialization with security but without additional physical requirements, e.g. connector keying or pin coding. Additionally disclosed are ways to increase system robustness by using wired communication to support the wireless communication and providing system information redundancy.

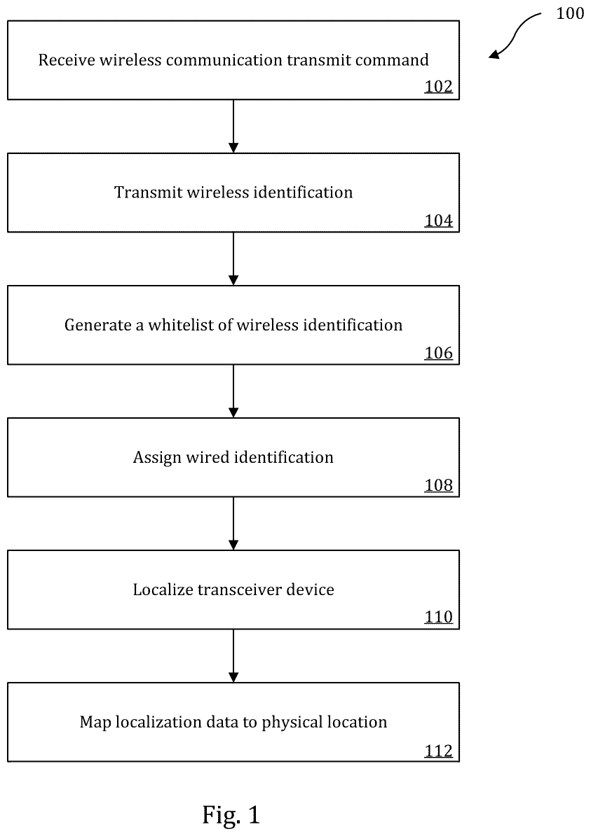

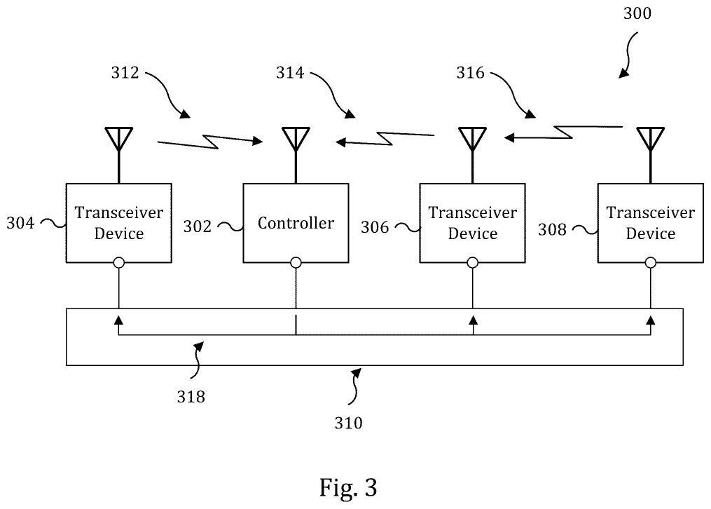

With reference to FIGS. 1, 2 and 3, in a first (100) and a second (200) exemplary method embodiments transceiver devices (304, 306, 308) initially have the same wired identification, for example the same CAN ID. Transceiver devices with the same wired identification may receive but generally do not respond or transmit on the wired network (310), e.g. CAN bus, unless addressed by their specific wireless identification, e.g. MAC. However, upon receiving from the wired network a wireless identification transmit command (102, 202, 318), each transceiver device responds with its wireless identification (104, 204, 312, 314, 316). The transceiver device may respond to the wireless identification transmit command, by, for example, communicating its wireless identification, either via the wired network (310), a wireless network (300), both wired and wireless, or otherwise, by narrowcast, broadcast or otherwise. The communication, such as, for example, transmissions, of the wireless identifications permit other network participants to learn about other devices connected to their networks. The transceiver devices may arbitrate and respond with their unique wireless identification, while the wired identification may not be used for this purpose, for example because the wired identification is not unique at that point.

Based on these transmissions a whitelist of one or more wireless identifications is generated (106, 206), preferably at a controller (302). The controller, for example, determines wireless identification of a transceiver device of at least one of high probability and confidence interval of belonging to the wired network.

With reference to FIG. 1, in the first exemplary embodiment the controller assigns and communicates a specific unique wired identification to the transceiver device (108) with, for example, the at least one of high probability and confidence interval of belonging to the wired network. The controller optionally repeats determining and assigning the next lower at least one of high probability and confidence interval transceiver device until a predetermined number of transceiver devices have been assigned unique wired identifications. Other orderings of assignments are possible without departing from the spirit of the invention.

Each transceiver device listens to at least one of, but preferably both, wired and wireless communications to facilitate constructing transceiver device map assignments. Each transceiver device communicates with at least one of the controller and other transceiver devices to localize (110). At least one of the controller and the individual transceiver devices map the localization data to physical locations (112).

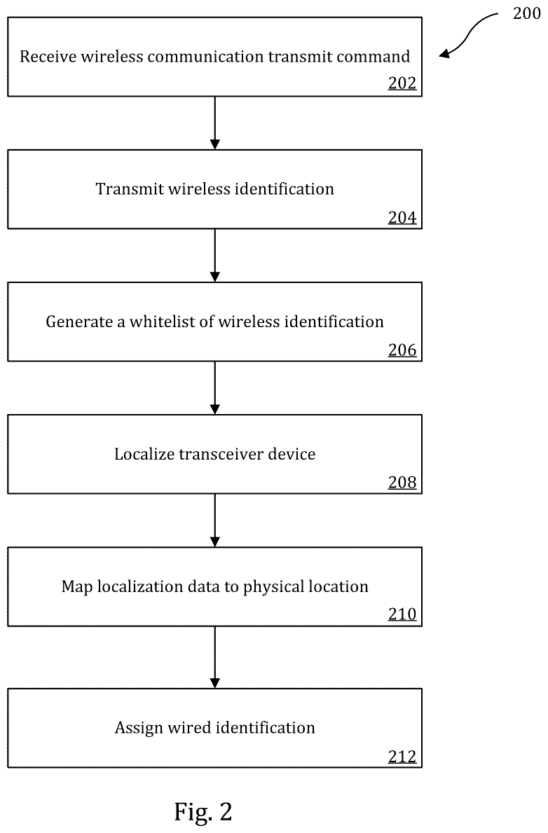

With reference to FIG. 2, in the second exemplary embodiment each transceiver device communicates with at least one of the controller and other transceiver devices to localize (208). At least one of the controller and the individual transceiver devices map the localization data to physical positions (210) or optionally communicate the localization data or the mapped physical positions to at least one other one of the controller and other transceiver devices to map the localization data to physical positions. Based on the mapped physical positions wired identifications are assigned (212), preferably by the controller. The wired identifications may uniquely identify the perceived physical locations of the transceiver devices. The wired identifications are then communicated to the mapped transceiver devices utilizing their respective wireless identifications. The mapping and communicating may be performed all at once or in stages, for example in order of the at least one of high probability and confidence interval of belonging to the wired network. However, other orderings of mapping or communicating are possible without departing from the spirit of the invention.

In an aspect a method for transceiver device assignment and position initialization comprises triggering at least one transceiver device to communicate its wireless identification; establishing bidirectional communication with the at least one transceiver device; and assigning wired identification to the at least one transceiver device by utilizing the wireless identification. The bidirectional communication may be established via wired communication, wireless communication or a combination of wired and wireless combination, or otherwise. For example, a leg, path, or medium of the communication may be wired and another leg, path, or medium may be wireless. It is also conceivable that communication in either direction is mediated by an intermediary, for example the controller or another transceiver device.

In an aspect the wired identification is assigned via wireless communication and in another aspect the wired identification is assigned via wired communication. The wired identification may be CAN id or otherwise.

It is understood that the triggering may be initiated at a central controller or otherwise and may occur via wired communication or otherwise.

In an aspect a central controller assigns at least one wireless channel to the at least one transceiver device, but non-central controllers or other devices may also be capable of performing this function in lieu of or in addition to the central controller. The wireless channel may be assigned via wired communication, or otherwise.

The wireless communication may be, for example, at least one of Bluetooth wireless communication, Bluetooth Low Energy (BLE), Wi-Fi, UWB, Zigbee, RFID, Nearlink, IR, RF communication, and LF communication, or otherwise. Whereas the wired communication may be, for example, at least one of Ethernet, Automotive Ethernet, CAN, HSCAN, LSCAN, MSCAN, CANFD, SPI, LIN, FlexRay, 12C, Kline, or otherwise.

Moreover, at least one of leg, path and medium of the bidirectional communication may be cryptographically protected.

In an aspect the wireless identification is collected from the at least one transceiver device and mapped to a respective wired identification. The wired identification may be based on a location of the at least one transceiver device, or otherwise. The location of the at least one transceiver device may be ascertained by wireless localization. Some of the wireless localization utilized may be MAC based localization, BLE localization, or otherwise.

In an aspect the collecting may comprise receiving at least one wireless identification relayed from another transceiver device by the at least one transceiver device.

It is understood that establishing bidirectional wireless communication may comprise relaying messages at least one of to, through, or from another transceiver device by the at least one transceiver device. Similarly, the assigning wired identification may comprise relaying the wired identification to or through another transceiver device by the at least one transceiver device.

Ascertaining the location by wireless localization may involve comparing characteristics of the bidirectional communication to a predetermined communication characteristic map. The comparing may comprise pattern recognition between a characteristic of the bidirectional communication and the predetermined communication characteristic map. The comparing may also comprise applying or updating a predetermined artificial intelligence model.

Some of the ways for ascertaining the location by wireless localization may comprise analyzing at least one of propagation delay, time of flight, reflection, angle of arrival, channel sounding, high accuracy distance measurements, safety relevant distance estimation, core high accuracy distance measurement, phase difference, and RSSI.

A controller for transceiver device assignment and position initialization may be configured to perform some or all of the above-mentioned actions. Similarly, a non-transitory computer readable medium may contain program instructions for transceiver device assignment and position initialization, wherein execution of the program instructions by one or more processors of a computer system causes the one or more processors to carry out some or all of the above-mentioned actions. The controller may be configured to establish wired communication with the at least one transceiver device utilizing the assigned wired identification. Similarly, a non-transitory computer readable medium may contain the instruction to do so.

Once the wired identification is assigned wired communication may be established with the at least one transceiver device utilizing the assigned wired identification.

It is understood that a transceiver device is a device comprising one or more transceivers, receivers and transmitters. The transceivers, receivers and transmitters may utilize wired or wireless communications or otherwise to at least one of transmit and receive signals. Preferably, a transceiver device is a device comprising at least one wired receiver and at least one wireless transmitter.

1. A method for transceiver device assignment and position initialization comprising:
triggering at least one transceiver device to communicate its wireless identification;
establishing bidirectional communication with the at least one transceiver device; and
assigning wired identification to the at least one transceiver device by utilizing the wireless identification.

2. The method as claimed in claim 1, wherein the communication of wireless identification is wireless.

3. The method as claimed in claim 1, wherein the wired identification is assigned via at least one of wireless and wired communication.

4. The method as claimed in claim 1, wherein the triggering is initiated via wired communication.

5. The method as claimed in claim 1, wherein a central controller assigns at least one wireless channel to the at least one transceiver device.

6. The method as claimed in claim 1, wherein wireless communication is at least one of Bluetooth wireless communication, BLE, Wi-Fi, UWB, Zigbee, RFID, Nearlink, IR, RF communication, and LF communication or wherein wired communication is at least one of Ethernet, Automotive Ethernet, CAN, HSCAN, LSCAN, MSCAN, CANFD, SPI, LIN, FlexRay, 12C, Kline.

7. The method as claimed in claim 1, wherein at least one of leg, path and medium of the bidirectional communication is cryptographically protected.

8. The method as claimed in claim 1, further comprising collecting the wireless identification from the at least one transceiver device and mapping the wireless identification to a respective wired identification.

9. The method as claimed in claim 8, wherein the collecting comprises receiving at least one wireless identification relayed from another transceiver device by the at least one transceiver device.

10. The method as claimed in claim 1, wherein the wired identification is based on a location of the at least one transceiver device.

11. The method as claimed in claim 10, wherein the location of the at least one transceiver device is ascertained by wireless localization.

12. The method as claimed in claim 11, wherein the wireless localization is at least one of MAC based localization and BLE localization.

13. The method as claimed in claim 11, wherein the ascertaining of the location by wireless localization comprises comparing a characteristic of the bidirectional communication to a predetermined communication characteristic map.

14. The method as claimed in claim 13, wherein the comparing comprises pattern recognition between a characteristic of the bidirectional communication and the predetermined communication characteristic map or at least one of applying and updating a predetermined artificial intelligence model.

15. The method as claimed in claim 11, wherein the ascertaining of the location by wireless localization comprises analyzing at least one of propagation delay, time of flight, reflection, angle of arrival, channel sounding, high accuracy distance measurements, safety relevant distance estimation, core high accuracy distance measurement, phase difference, and RSSI.

16. The method as claimed in claim 1, wherein establishing bidirectional wireless communication comprises relaying messages at least one of to and from another transceiver device by the at least one transceiver device.

17. The method as claimed in claim 1, wherein the assigning wired identification comprises relaying the wired identification to another transceiver device by the at least one transceiver device.

18. A controller for transceiver device assignment and position initialization configured to:
trigger at least one transceiver device to communicate its wireless identification;
establish bidirectional communication with the at least one transceiver device; and
assign wired identification to the at least one transceiver device by utilizing the wireless identification.

19. A non-transitory computer readable medium containing program instructions for transceiver device assignment and position initialization, wherein execution of the program instructions by one or more processors of a computer system causes the one or more processors to carry out the steps of:
triggering at least one transceiver device to communicate its wireless identification;
establishing bidirectional communication with the at least one transceiver device;
assigning wired identification to the at least one transceiver device by utilizing the wireless identification.

20. The non-transitory computer readable medium as claimed in claim 19, wherein the steps further comprise:
establishing wired communication with the at least one transceiver device utilizing the assigned wired identification.
